(19) United States
(12) Patent Application Publication
(10) Pub. No.: US 2012/0265629 A1
(43) Pub. Date: Oct. 18, 2012

(54) Marketplace for multidimensional personal development plans

(76) Inventor: Deepak Ayyagari, Potomac, MD (US)

(21) Appl. No.: 13/066,338

(22) Filed: Apr. 12, 2011

(51) Int. Cl. G06Q 50/00

(52) U.S. Cl. 705/26.1

(57) ABSTRACT

A marketplace for personal development plans operates within a multidimensional personal development system. The marketplace enables a plan provider within the personal development system to create and market and users within the personal development system to search, acquire and implement personal development plans that track experiences, track facets and subfacets of a user's state of being impacted by the experiences and provide assessments that yield feedback to users relative to the plan. The marketplace is adaptable for implementation in both a server-centric or client-centric architecture.

### CROSS-REFERENCE TO RELATED APPLICATION(S)

This application has subject matter related to the following U.S. nonprovisional applications, both having filing dates concurrent herewith, and both of which are incorporated herein by reference: Ser. No. ______ entitled “SYSTEM AND METHOD FOR MULTIDIMENSIONAL PERSONAL DEVELOPMENT USING DEFINED FACETS AND SUBFACETS;” and Ser. No. ______ entitled “SYSTEM AND METHOD FOR MULTIDIMENSIONAL PERSONAL DEVELOPMENT USING DEFINED EXPERIENCES.”

### BACKGROUND OF THE INVENTION

Human beings have introspective, interactive and incidental experiences in distinct yet overlapping spheres of their lives that impact their state of being in the past, present and future. Two examples of life spheres are an individual's professional life and physical aspect. In each of these spheres, the individual has experiences specific to the sphere. In the professional sphere, experiences may include networking, job seeking and business communications. In the physical sphere, experiences may include a diet and workout regimen. In addition to sphere specific experiences, most individuals have common experiences that can affect the individual's state of being across multiple life spheres. These common experiences, which are widely shared by human beings, include eating, sleeping, social interactions, reading, thinking and sex.

Within each life sphere, an individual is characterized by a state of being. In the examples above, the individual's state of being in his or her professional life may include being a professionally content manager at a company with adequate monetary compensation. The individual's state of being in his or her physical aspect may include attributes such as being slightly overweight with above average body mass index, average blood pressure and heart rate and a propensity for sweet food. The state of being is time variant in almost every life sphere based on new experiences. There is also often a dichotomy in the state of being between what the individual actually is (descriptive state) and what the individual would like to be (aspirational state). Thus, there are multiple views of the state of being within every life sphere and dimension.

Individuals who move their descriptive state of being closer to their aspirational state of being can profoundly improve their happiness and quality of life. Yet human beings often fail to clearly understand the multiple spheres of their existence, set aspirational goals in these spheres and/or comprehend how their sphere specific and common experiences impact on these spheres.

### SUMMARY OF THE INVENTION

The present invention provides a marketplace for a multidimensional personal development plans. The marketplace operates within a personal development system. Features of the system include defining and tracking different facets of a user's state of being and different subfacets within these facets, enabling the user to define additional subfacets that are pivotal to the user and track these pivotal subfacets, defining and tracking different experiences that impact on the facets and subfacets, enabling the user to record evolving perceptions relative to the experiences and evolving descriptive states relative to the subfacets, enabling the user to view and share the evolving descriptive states over time and relative to aspirational states recorded by the user, applying the evolving perceptions, evolving descriptive states and aspirational states to compute and present indicators that summarize the user's progress and momentum relative to the facets and subfacets. The marketplace enables plan providers operating within the personal development system to create and market and users to search, acquire and implement personal development plans that track experiences, track facets and subfacets impacted by the experiences and provide assessments that yield feedback to users relative to the plan. The marketplace is adaptable for implementation in both a server-centric or client-centric architecture.

In one aspect of the invention, a method for providing a personal development plan marketplace in a multidimensional personal development system, comprising the steps of receiving, by a server system, from a plan provider, a personal development plan created by the plan provider, wherein the plan defines one or more experiences to be monitored under the plan and one or more facets of a state of being targeted by the plan; adding the plan, by the server system, to a plan marketplace maintained by the server system; receiving, by the server system, from a user, a request for information about plans in the plan marketplace; transmitting, by the server system, to the user, information about the plan in response to the request; receiving, by the server system, from the user, a request to acquire the plan; importing the plan, by the server system, into an account of the user in response to the request; receiving, by the server system, from the user, perceptions inputted by the user over time relative to the experiences; and transmitting, by the server system, to the user, assessments of the plan provider over time relative to the user and the plan.

In some embodiments, the assessments are human assessments made in a live chat session.

In some embodiments, the assessments are human assessments made in messages outside of a live chat session.

In some embodiments, the assessments are automated assessments.

In some embodiments, the automated assessments comprise momentum indicators generated by the server system relative to the one or more facets.

In some embodiments, the automated assessments comprise progress indicators generated by the server system relative to the one or more facets.

In some embodiments, the assessments are based at least in part on the perceptions.

In some embodiments, the method further comprises he step of receiving, by the server system, from the user, descriptive states inputted by the user over time relative to one more more subfacets within the one or more facets.

In some embodiments, the plan recommends aspirational states relative to the one or more subfacets.

In some embodiments, the plan defines asipirational states relative to the one or more subfacets.

In some embodiments, the assessments are based at least in part on the descriptive states.

In some embodiments, the method further comprises the step of receiving, by the server system, from the user, payment information for the plan.

In some embodiments, the one or more facets include a persona facet.

In some embodiments, the one or more facets include a professional facet.

In some embodiments, the one or more facets include a spiritual facet.

In some embodiments, the one or more facets include an intellectual facet.

In some embodiments, the one or more facets include a family and friends facet.

In some embodiments, the one or more facets include a world views facet.

In some embodiments, the one or more facets include a physical facet.

In some embodiments, the experiences include deeds.

In some embodiments, the experiences include thoughts.

In some embodiments, the experiences include emotions.

In some embodiments, the experiences include random experiences.

In another aspect of the invention, a server system comprises at least one network interface; and a processor communicatively coupled with the network interface, wherein the server system receives from a plan provider via the network interface a personal development plan created by the plan provider, wherein the plan defines one or more experiences to be monitored under the plan and one or more facets of a state of being targeted by the plan, wherein the server system under control of the processor adds the plan to a plan marketplace maintained by the server system, wherein the server system receives from a user via the network interface a request for information about plans in the plan marketplace and transmits to the user via the network interface information about the plan in response to the request, wherein the server system receives from the user via the network interface a request to acquire the plan and under control of the processor imports the plan into an account of the user in response to the request, and wherein the server system receives from the user via the network interface perceptions inputted by the user over time relative to the experiences and transmits to the user via the network interface assessments of the plan provider over time relative to the user and the plan.

In another aspect of the invention, a user input/output (I/O) system comprises at least one user interface; at least one network interface; and a processor communicatively coupled with the user interface and the network interface, wherein the user I/O system receives from a server system via the network interface a personal development plan created by a plan provider defining one or more experiences to be monitored under the plan and one or more facets of a state of being targeted by the plan, wherein the user I/O system under control of the processor imports the plan into an account of a user of the user I/O system, wherein the user I/O system receives from the user via the user interface perceptions inputted by the user over time relative to the experiences, and wherein the user I/O system transmits to the user via the user interface assessments of the plan provider over time relative to the user and the plan.

In yet another aspect of the invention, a user I/O system, comprises at least one user interface; and at least one network interface, wherein the user I/O system receives via the user interface from a plan provider a personal development plan defining one or more experiences to be monitored under the plan, one or more facets of a state of being targeted by the plan, one or more assessment methods for assessing users of the plan and payment information for the plan, and wherein the user I/O system transmits the plan to a server system via the network interface, whereupon the plan is added to a searchable plan marketplace.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a communication system in which the invention is operative in server-centric embodiments.

FIG. 2 shows a server system in some embodiments of the invention.

FIG. 3 shows server-side resources in some embodiments of the invention.

FIG. 4 provides a functional representation of a personal development system in some embodiments of the invention.

FIG. 5 is a flow diagram of a personal development method in some embodiments of the invention.

FIG. 6 shows a user screen for viewing and modifying pivotal subfacets of a state of being in some embodiments of the invention.

FIG. 7 shows a user screen for viewing and modifying descriptive states relative to subfacets of a state of being in some embodiments of the invention.

FIG. 8 shows a user screen for viewing and modifying perceptions relative to experiences in some embodiments of the invention.

FIG. 9 shows a user screen for viewing and comparing past and present and descriptive states and aspirational states relative to subfacets of a state of being within a facet in some embodiments of the invention.

FIG. 10 shows a user screen presenting progress and momentum indicators in some embodiments of the invention.

FIG. 11 is a flow diagram of a method for computing a progress percentage for a subfacet of a state of being in some embodiments of the invention.

FIG. 12 is a flow diagram of a method for computing a progress percentage for a facet of a state of being in some embodiments of the invention.

FIG. 13 is a flow diagram of a method for computing a momentum percentage for a subfacet of a state of being in some embodiments of the invention.

FIG. 14 is a flow diagram of a method for computing a momentum percentage for a facet of a state of being in some embodiments of the invention.

FIG. 15 is a flow diagram of a method for creating a personal development plan in some embodiments of the invention.

FIG. 16 shows a user screen for providing a plan overview in some embodiments of the invention.

FIG. 17 shows a user screen for defining plan experiences in some embodiments of the invention.

FIG. 18 shows a user screen for defining plan assessment methods in some embodiments of the invention.

FIG. 19 shows a user screen for plan review and publication in some embodiments of the invention.

FIG. 20 shows a user screen of a plan marketplace in some embodiments of the invention.

FIG. 21 shows a user screen for viewing and modifying experience-facet correlations in some embodiments of the invention.

FIG. 22 shows a communication system in which the invention is operative in client-centric embodiments.

FIG. 23 shows a user I/O system in some embodiments of the invention.

### DETAILED DESCRIPTION OF A PREFERRED EMBODIMENT

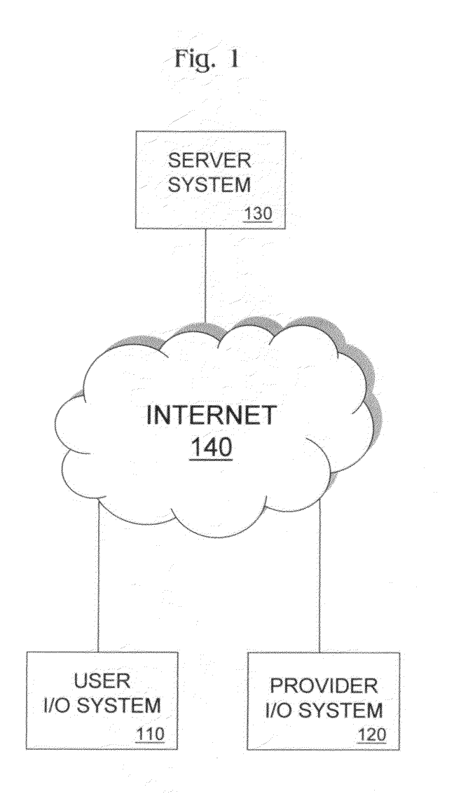

FIG. 1 shows a communication system in which the invention is operative in server-centric embodiments. The communication system includes a user I/O system 110 and a provider I/O system 120 communicatively coupled to a server system 130 via the Internet 140.

User I/O system 110 and provider I/O system 120 are Internet-capable computing devices, such as desktop computers, notebook computers, tablet computers, netbook computers, smart phones or Internet appliances. User I/O system 110 and provider I/O system 120 each have a network interface, a processor executing web browser software and human I/O devices, such as a keyboard and mouse, for engaging in bidirectional communication with server system 140 via Internet 130 to perform their respective roles in the personal development system of the invention. User I/O system 110 receives input from and displays output to a human user of the personal development system. Provider I/O system 120 receives input from and displays output to a human plan provider of the personal development system. While one user I/O system 110 and one provider I/O system 120 are shown for simplicity, multiple user I/O systems and provider I/O systems will normally be operative in the personal development system. Moreover, I/O systems may serve as both user and provider I/O systems.

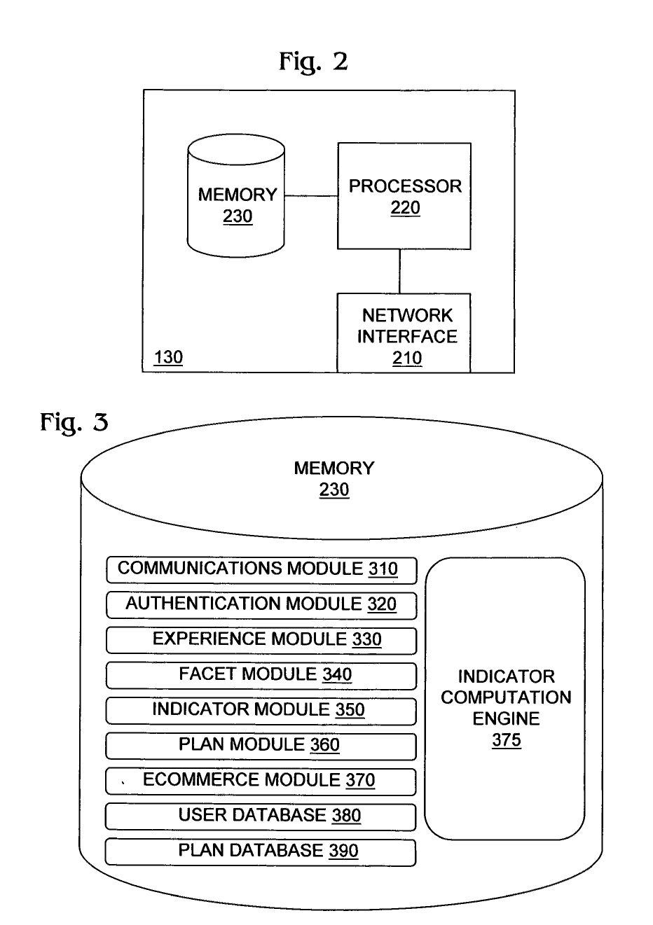

FIG. 2 shows server system 140 in some embodiments of the invention. Server system 140 includes a processor 220 communicatively coupled between a network interface 210 and a memory 230. Server system 140 engages in bidirectional communication with user I/O system 110 and provider I/O system 120 via network interface 210, under the control of processor 220 and invoking server-side resources stored in memory 230, to perform its role in the personal development system of the invention. Server system 140 receives via network interface 210 input inputted by users and plan providers of the personal development system, processes the input, and transmits via network interface 210 output to the users and plan providers. While server system 140 is illustrated as a single server node, in some embodiments the elements and functions shown and described herein as being associated with server system 140 may be distributed across multiple network nodes. Moreover, in some embodiments, one or more of the elements and functions shown and described herein as being associated with server system 140 may be implemented on user I/O system 110 and/or provider I/O system 120.

FIG. 3 shows server-side resources in some embodiments of the invention to include modules 310-370, indicator computation engine 375 and databases 380, 390. In some embodiments, modules 310-370 and indicator computation engine 375 are software programs having instructions executable by processor 220 to perform their respective roles in the personal development system of the invention. Databases 380, 390 are relational databases storing information accessed and used by modules 310-370 and engine 375 in fulfilling their respective roles. In other embodiments, one or more of modules 310-370 and/or engine 375 may be implemented in custom integrated circuitry.

Communications module 310 manages Internet connections between server system 130, on the one hand, and user I/O system 110 and provider I/O system 120, on the other, via network interface 210.

Authentication module 320 manages login attempts to server system 130 by a user on user I/O system 110 and a plan provider on provider I/O system 120. Authentication module 320 verifies credentials inputted by the user or plan provider before allowing the user I/O system 110 or provider I/O system 120 to access the user's or provider's account information stored on user database 380.

Experience module 330 collects and manages a data record of the user's perceptions over time relative to different experiences. Experience module 330 renders on user I/O system 110 web pages showing the most recent perceptions of the user relative to experiences and solicits input from the user on his or her present perceptions relative to these experiences. The experiences are presented as descriptive text and the perceptions are inputted as numeric scores (e.g., an integer from one to five, with five being the most favorable state). Experience module 330 time-stamps and records the perceptions to create an evolving record of perceptions and stores the evolving record of perceptions in the user's account within user database 380. Experience module 330 allows the user to access the evolving record of perceptions and view the user's past perceptions at times specified by the user.

The user's perceptions are recorded in four categories of experiences: deeds, thoughts, emotions and random. Deeds include actions and activities undertaken by the user. Thoughts include thoughts experienced by the user. Emotions include emotions experienced by the user. Random includes random occurrences experienced by the user. Each experience category includes multiple discrete experiences. The experiences may includes generic experiences defined by a system administrator and/or custom experiences defined by a provider of a personal development plan purchased by the user and imported from plan database 390.

In some embodiments, generic experiences within the deeds experience category include eat and drink healthy, physical workout, social interactions, worked to full potential, actions benefiting family and friends, spiritual actions, acts of pleasure and actions benefiting the world.

In some embodiments, generic experiences within the thoughts experience category include mental work, nature of thoughts, thoughts on friends and family, thoughts on the world, developed new intellectual insight and developed new wisdom.

In some embodiments, generic experiences within the emotions experience category include emotional levels, nature of emotions, emotions toward self, emotions toward friends and family, emotions at work and emotions toward the world.

In some embodiments, generic experiences within the random experience category include random effects on physical state, random effects on emotional state, random effects on intellectual state, random effects on spiritual state, random effects on professional state, random effects on material state, random effects on family and friends and random effects on world views.

In other embodiments, the number and topics of experience categories and experiences may differ.

Facet module 340 acquires and manages a data record of the user's state of being over time relative to different subfacets. Facet module 340 renders on user I/O system 110 web pages showing the most recent descriptive states of the user relative to subfacets and solicits input from the user on his or her present perceptions relative to these subfacets. Subfacets are presented as descriptive text and the descriptive states are inputted as numeric values (e.g., an integer from one to five with five being the most favorable). In other embodiments, descriptive states may be inputted as descriptive text. Facet module 340 time-stamps the descriptive states to create an evolving record of descriptive states and stores the evolving record in the user's account within user database 380. Facet module 340 allows the user to access the evolving record of descriptive states and view the user's past descriptive states at times specified by the user. Facet module 340 also allows the user to compare past descriptive states with present descriptive states by rendering on user I/O system 110 web pages that juxtapose past descriptive states and present descriptive states.

The user's descriptive states are recorded for subfacets in seven predefined facets: persona, family and friends, intellectual, spiritual, professional, world views and physical. The persona facet includes subfacets relative to the user's personal life and personality as projected to the external world. The family and friends facet includes subfacets relative to the human relationships dimension of the user's existence. The intellectual facet includes subfacets relative to the intellectual dimension of the user's life. The spiritual includes subfacets relative to the spiritual dimension of the user's life. The professional includes subfacets relative to the professional dimension of the user's life. The world views facet includes subfacets relative to ideas, opinions and views the user holds on worldly matters such as social, political and environmental matters. The physical facet includes subfacets relative to the user's physical aspect. Each facet includes multiple discrete subfacets. The subfacets may include generic subfacets defined by a system administrator, pivotal subfacets defined by the user and/or custom subfacets defined by a provider of a personal development plan purchased by the user and imported from plan database 390.

In some embodiments, generic subfacets within the persona facet include emotional state, emotional balance, emotional history, current emotional influences, pursuit of pleasure, personal ambition, creativity, artistic inclinations, dominant nature, risk taker, seeking new people, seeking new experiences, self-confidence, self-image, self-control, self-centric, personal accountability, material wealth, material needs and future outlook.

In some embodiments, generic subfacets within the family and friends facet include state of family relations, state of relations with parents, state of relations with partners, state of relations with siblings, state of relations with sons and daughters, state of relations with friends, history of family relationships, history of friends relationships, open to changes in family relations, open to changes in friendships, acceptance of family, acceptance of friendships, personal responsibility in family relations, personal responsibility in friendships, thrive on interactions, trust in family friendships, trust in friendships, dominance in relations, empathetic to family, empathetic to friends, selfishness, stability in family relations, stability in friendships, dependence of family and friends.

In some embodiments, generic subfacets within the spiritual facet include humility, convictions, happiness, spiritual contentment, balance, peace, faith, tolerance, self-awareness, self-questioning, self-centric, enlightenment, material desires, spiritual desires, empathy, discipline in practice, spiritual effort, open to new spiritual ideas and ways, degree of wisdom, spiritual history.

In some embodiments, generic subfacets within the intellectual facet include intellectual curiosity, seek debate and discussion, open to growth and change, intellectual strength, intellectual discipline, intellectual self-awareness, intellectual self-evaluation, intellectual self-satisfaction, intellectual dominance, degree of knowledge.

In some embodiments, generic subfacets within the professional facet include professional state, satisfaction with current job, pleasure from current job, remuneration, level of education, level of experience, interpersonal relationships, relationship with superiors, relationship with subordinates, achievements, professional ambitions, work ethic, professional competence, discipline, work-life balance, professional accountability, emotions at work, career progression.

In some embodiments, generic subfacets within the world views facet include emotion inspired views, analysis inspired views, imagination inspired views, positive/negative views, empathy in views, open to growth and change, seek discourse and debate, awareness of issues, self-evaluation and introspection, satisfaction with important views, degree of knowledge and outlook on views.

In some embodiments, generic subfacets within the physical facet include state of general health, state of physical fitness, state of mental/emotional fitness, state of diseases, satisfaction with physical state, satisfaction with mental state, sexual desire, sexual activity, motivation, awareness, discipline in practice, open to change and growth, self-confidence, physical demands, mental demands, stress levels, coping with stress levels, hormone balance, cost of health, height, weight, body max index, systolic blood pressure, diastolic blood pressure, blood glucose, blood oxygen, heart rate, respiratory rate, vision and other vitals.

In other embodiments the number and topics of facets and subfacets may differ.

Facet module 340 also collects and manages a data record of the user's aspirational states relative to the subfacets through inputs on the web pages. Facet module 340 records the aspirational states in the user's account within user database 380. Facet module 340 allows the user to compare present descriptive states with aspirational states by rendering on user I/O system 110 web pages that juxtapose present descriptive states and aspirational states.

Facet module 340 also collects and manages a data record of the user's pivotal subfacets relative to aspects of the user's state of being that the user regards as particularly important or influential in his or her life. Facet module 340 renders on user I/O system 110 web pages soliciting input from the user relative to pivotal subfacets. The user inputs pivotal subfacets as descriptive text, and if the user desires change relative to a pivotal subfacet, he or she may indicate an aspirational state relative to the pivotal subfacet as descriptive text or a numeric score.

In some embodiments, pivotal subfacets within all facets include a pivotal personal emotion, a pivotal thought or concern, a pivotal personal desire or need, a pivotal personal activity and a pivotal influence, which may be a person or event.

Facet module 340 provides additional functions on a “per facet” basis, including assessments, comments, diary, facts and media, ratings and web log.

Facet module 340 collects and manages a data record of facet specific assessments relative to personal development plans purchased by the user from a plan provider. These assessments may include textual and/or graphical self-assessments received from the user, automated assessments generated by facet module 340 using the evolving record of perceptions or descriptive states and/or provider assessments received from the plan provider.

Facet module 340 collects and manages a data record of facet specific comments that allows other users to post comments on the user's state of being relative to the facet and/or subfacets within the facet and allows the user to review the comments.

Facet module 340 collects and manages a data record of facet specific diary entries that allow the user to record his or her experiences relative to the facet and/or subfacets within the facet on a daily, weekly or other periodic basis and review the periodic entries.

Facet module 340 collects and manages a data record of facet specific facts and media for the user. For example, for the professional facet, facet specific facts and media may include the user's current job, educational background, publications, online resume and/or introductory professional video.

Facet module 340 collects and manages a data record of facet specific ratings that allow other users to post ratings on the user's state of being relative to the facet and/or subfacets within the facet and allow the user to review the ratings.

Facet module 340 collects and manages a data record of facet specific web log entries that allow the user to create time-stamped text and graphics posts on different topics relative to the facet and/or subfacets within the facet. Other users may view the posts and comment.

Facet module 340 provides additional functions that can be invoked by the user from within any facet. These functions include live chat and services.

Facet module 340 provides a live chat function that allows the user to initiate and participate in a live chat session with other users who are logged-in to the personal development assessment system. The initiating user pushes a live chat button on a facet web page rendered on user I/O system 110. The initiating user is then queried for the identity of the other user with whom the user wishes to establish a live chat session. Facet module 340 consults user database 380 to determine whether the other user is logged-in. If the other user is not logged-in, facet module 340 notifies the initiating user that the other user is unavailable for live chat. If the other user is logged-in, facet module 340 launches a live chat console on user I/O system 110 and sends a request to the other user to enter the live chat console by clicking the live chat button. The request is reiterated whenever the other user moves to a different web page or refreshes the current web page. If the other user clicks the live chat button and enters the live chat console, the initiating user and the other user can engage in voice, video and/or text communication in a live chat session within the live chat console.

Facet module 340 provides a services function that allows the user to activate services that he or she wishes to offer to other users relative to a facet, such as consulting services or a personal development plan. The user pushes a services button on a facet web page rendered on user I/O system 110, at which point facet module 340 directs the user to a web page presenting the user with a list of selectable service options (e.g., consulting, plan provider). The user then selects from among the service options, at which point facet module 340 directs the user to a web page for the selected service. The web page for the selected service queries the user for details pertaining the user's proposed service offering for the selected service.

Facet module 340 provides a time track function that allows the user to select whether or not to keep an historical record of descriptive states for each subfacet. The time track function can be individually set for each subfacet. When time track is set for a particular subfacet and the descriptive state for the subfacet changes, the descriptive state is time-stamped and recorded in the user's account within user database 380, creating a history of the descriptive state for the subfacet that is available for later use and viewing. When time track is not set for a particular subfacet and the descriptive state for the subfacet changes, no history of the descriptive state for the subfacet is maintained.

Facet module 340 provides an access control function that protects data records managed by facet module 340 from unauthorized viewing and use. Access control can be individually set for each subfacet, as well as for the assessments, comments, diary, facts and media, ratings and web log. The user can select one of three access control options: public, private and access list. A public setting allows access by all other users. A private setting blocks access by all other users. An access list setting allows access only by other users who are identified in an access control list specified by the user.

Facet module 340 provides a change wanted function that allows the user to specify whether to change is desired relative to the present descriptive state of each subfacet. The change wanted function can be individually set for each subfacet. The change wanted setting impacts on percentages reported relative to progress and momentum indicators computed for facets and subfacets.

Indicator module 350 presents graphical indicators of the user's progress and momentum relative to facets, subfacets and logical groups of subfacets. Indicator module 350 presents the graphical indicators on web pages rendered on user I/O system 110. The indicators are displayed as arrows having markers at distances along the length of the arrows that correspond to percentages of the user's progress or momentum relative to facets, subfacets and logical groups of subfacets. Indicator module 350 acquires the percentages from indicator computation engine 375, which computes the percentages.

The personal development system supports graphical indicators, including progress and momentum indicators. The percentage for a progress indicator ranges from 0% to 100% and reflects the difference between the descriptive state the aspirational state for a facet, subfacet or logical group of facets. The percentage for a momentum indicator ranges from −100% to 100% and reflects the direction and pace of change for a facet, subfacet or logical group of facets manifested in the user's inputs relative to experiences. Indicator module 350 also presents state indicators that represent an average descriptive state or aspirational state within a logical group of subfacets defined by the user. For example, the user may define a logical group all subfacets having to do with emotions and the mean descriptive state of these subfacets may be monitored. Indicator module 350 acquires the averages from indicator computation engine 375, which computes the averages.

Community progress, momentum and state indicators may also be generated and displayed that show an average progress, momentum or state percentage for a facet, subfacet or logical group of facets taken across a defined group of users or the entire community of users of the personal development system.

Plan module 360 supports creation, management and searching of personal development plans. When invoked by a plan provider (e.g., through the services function), plan module 360 renders web pages on user I/O system 110 or provider I/O system 120 that solicit information for a personal development plan offering. For example, the user may be asked to identify a target facet, provide plan description, and specify the cost of the plan, experiences to be tracked under the plan, subfacets to be tracked under the plan, and how experiences impact on the subfacets. The experiences and subfacets defined in a plan may include custom experiences and subfacets that supplement or replace generic experiences and subfacets defined by the system administrator. Once a plan is published, plan module 360 adds the plan to a list of plans, stored in plan database 390, that have been published by all plan providers. Plan module 360 also supports a plan search and retrieval function that renders matching web pages identifying the title and select details of plans in response to search queries made by users. Published plans may be accessed by plan name, provider name, provider background and/or plan cost, for example. Plan module 360 allows plan providers to modify or depublish their plans at any time. Moreover, plan module 360 allows plan providers to view a list of users who have acquired their plans as well as transaction details, such as purchase date, time and price.

Ecommerce module 370 is invoked by plan creation module 360 and provides transactional support (e.g., credit card processing) for plan purchases. When a user clicks a purchase button on a web page manifesting an intent to purchase a plan, ecommerce module 370 queries the user for payment method details, such as a credit card or bank account number. Ecommerce module 370 interfaces with a remote ecommerce transaction server to debit the identified user account in the amount of the plan list price, plus any applicable taxes. The plan provider's account, which is maintained in plan database 390, is credited in the amount of the debit less transaction fees defined by the system administrator and agreed to in advance by the plan provider.

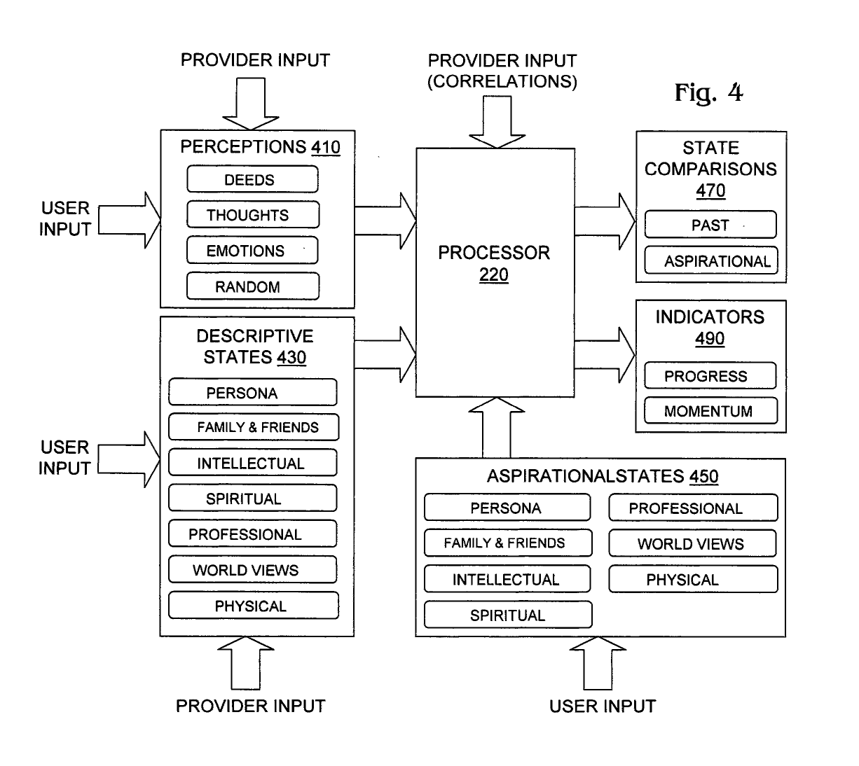

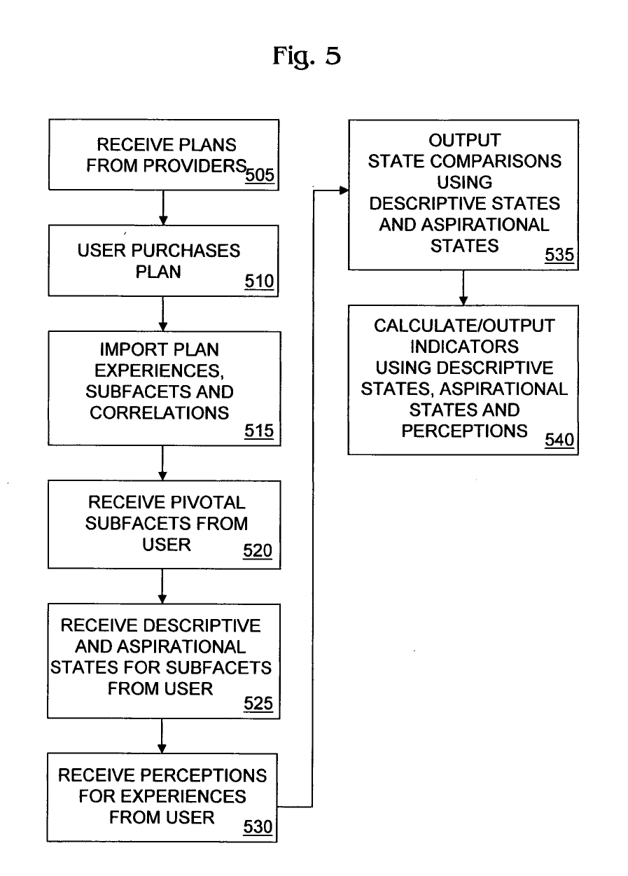

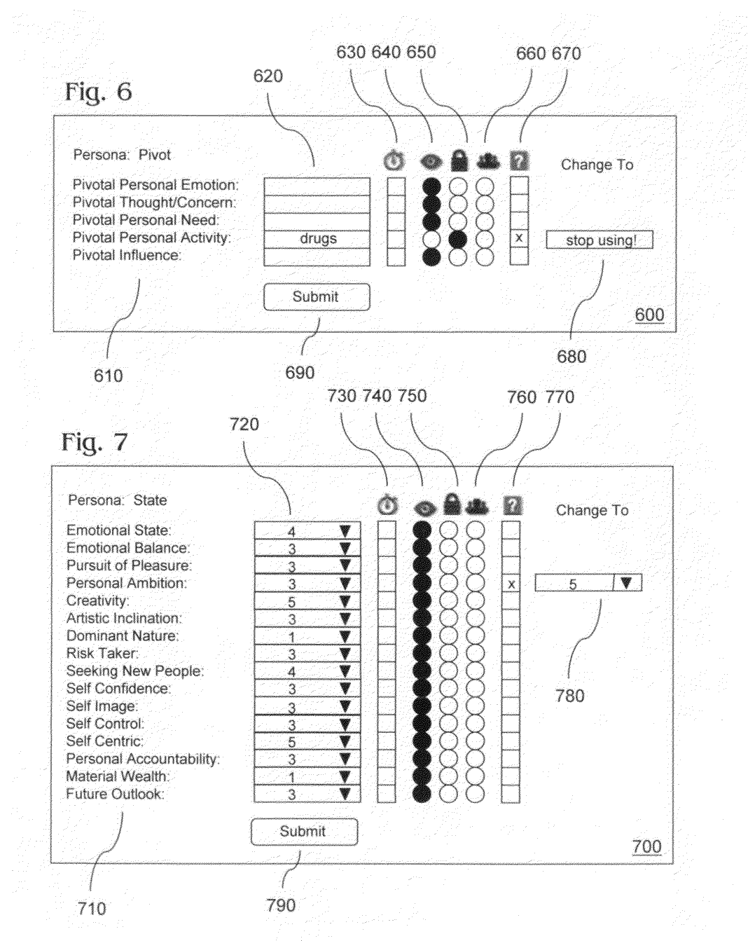

FIG. 5 provides a flow diagram of a personal development method performed by server system 130 under the control of processor 220 in some embodiments of the invention. The flow will be described in conjunction with FIG. 4, which provides a functional representation of an exemplary personal development assessment system operative on server system 130, as well as FIGS. 6-10, which show exemplary user screens outputted by server system 140 and rendered to the user on user I/O device 110 to facilitate the method.

At the outset, server system 130 receives personal development plans created by plan providers (505). These plans are created, for example, on provider I/O system 120 using inputs made by plan providers into web pages rendered by plan creation module 360. Plans define generic and custom experiences relevant to the plan within one or more categories of experiences. Plans also define correlations that define how experiences impact on the target facet and/or subfacets within the target facet when indicator computation engine 375 computes momentum indicators. Plans may also define generic and custom subfacets within the target facet that are relevant to the plan.

Next, the user interacts with server system 130 to purchase a plan (510). The purchase is made on user I/O system 110 through inputs made by the user into web pages rendered by plan creation module 360 and ecommerce module 370.

Next, server system 130 imports experience, subfacet and correlation definitions from the plan into the user's account (515). The experience definitions supplement or replace generic experiences defined by the system administrator. The subfacet definitions supplement or replace generic subfacets defined by the system administrator. The correlation definitions supplement or replace the correlations defined by the system administrator.

In other embodiments, the user does not purchase a plan and instead uses the generic experiences and subfacets defined by the system administrator, and any pivotal subfacets defined by the user, to assess personal development. In these embodiments, Steps 505-515 are bypassed.

Next, server system 130 receives pivotal subfacet definitions from the user (520). Turning to FIG. 6, for example, the user invokes the web browser on user I/O system 110 to navigate to a pivot input web page 600 on server system 130 for the persona facet. The user locates the most germane category for the pivotal subfacet (e.g., personal activity) and enters the pivotal subfacet (e.g., drugs) into a text box 620 associated with the category. The user then decides whether or not to time track the pivotal subfacet by checking or not checking a checkbox 630 and sets a desired access control setting to public 640, private 650 or access control list 660 by selecting a radio button. The user then decides whether or not the user wants change relative to the pivotal subfacet by checking or not checking a checkbox 670. If the user wants change, the user enters an aspirational state relative to the pivotal subfacet into text box 680. The user concludes by clicking a submit button 690, which activates the pivotal subfacet. The user may modify the pivotal subfacet at any time by returning to web page 600, and may activate and modify pivotal subfacets for other facets by similar means. The pivotal subfacet definitions are stored in user database 380.

Next, server system 130 receives from the user descriptive and aspirational states relative to subfacets (525). Subfacets have descriptive states 430 that answer the question “What am I?” and aspirational states 450 that answer the question “What would I like to be?” both of which are determined by user input. Turning to FIG. 7, for example, the user invokes the web browser on user I/O system 110 to navigate to a subfacet state change web page 700 on server system 130 for the persona facet. For each one of subfacets 710, the user selects his or her present descriptive state (e.g., a score from one to five, with five being the most favorable) from one of pull-down menus 720 associated with the subfacets. The user then decides whether or not to time track his or her descriptive state for the subfacet by checking or not checking a checkbox 730 and sets a desired access control setting to public 740, private 750 or access control list 760 by selecting a radio button. The user then decides whether or not he or she wants change relative to the descriptive state by checking or not checking a checkbox 770. If the user wants change, the user further sets an aspirational state relative to the subfacet (e.g., a score from one to five, with five being the most favorable) from a pull-down menu 780 associated with the subfacet. The user concludes by clicking a submit button 790, which records the selections made by the user in user database 380. The user may modify the selections at any time by returning to web page 700, and may set and modify descriptive and aspirational states for subfacets within other facets by similar means. It is contemplated that the user will update descriptive states regularly (e.g., weekly or monthly), with the descriptive states selected in each session being time-stamped (if the user has chosen to time track) and recorded to create a history of the user's descriptive states relative to facets.

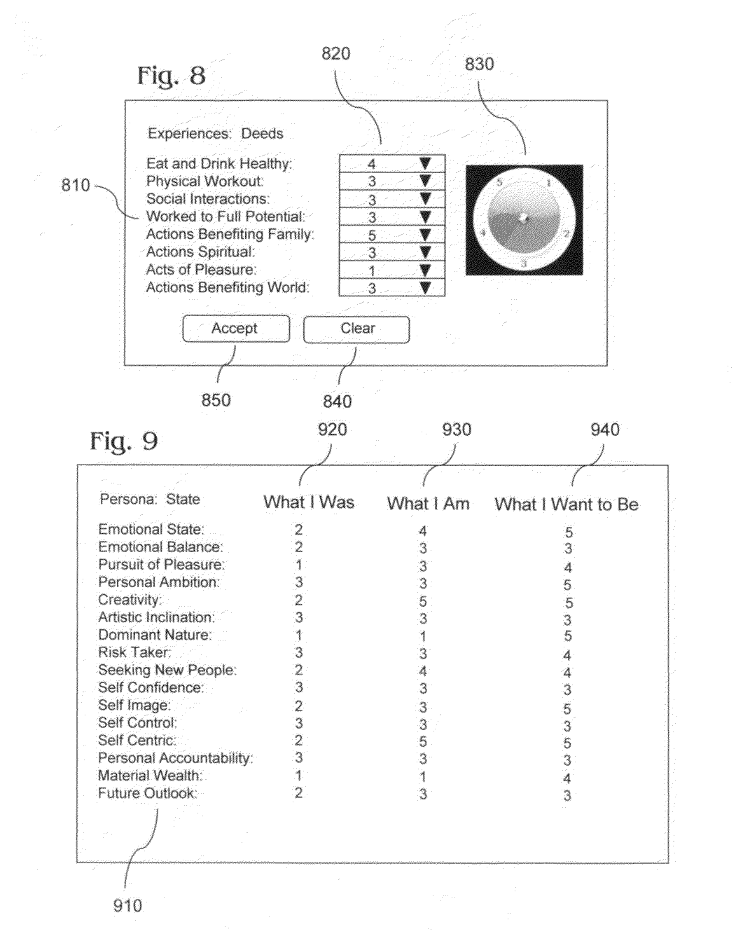

Next, server system 130 receives from the user perceptions relative to experiences 410 (530). Turning to FIG. 8, for example, the user invokes the web browser on user I/O system 110 to navigate to a perception input web page 800 on server system 130 for the deeds experience category. For each one of the defined experiences 810, the user selects his or her present perception (e.g., a score from one to five, with five being the most favorable) from pull-down menus 820 associated with the experiences. Alternatively, in some embodiments, the user can highlight one of experiences 810 and select his or her present perception relative to the highlighted experience though a mouse click on perception wheel 830. The user can clear selections by clicking a clear button 840 and conclude the input session by clicking an accept button 850, which causes the perceptions to be time-stamped an recorded. The user may record new perceptions at any time by returning to web page 800, and may record perceptions relative to other experience categories by similar means. It is contemplated that the user will update perceptions regularly (e.g., daily or weekly), with the perceptions inputted in each session being time-stamped and recorded in user database 380 to create a history of the user's perceptions relative to experiences.

The user inputs received in Steps 520-530 provide the basis for outputs that allow the user to assess personal development from several unique visual perspectives. These perspectives allow the user to view his or her present descriptive state (e.g., what I am) in juxtaposition with his or her past descriptive state (e.g., what I was) at a time specified by the user. These perspectives also allow the user to present his or her present descriptive state in juxtaposition with his or her aspirational state (e.g., what I want to be). Accordingly, server system 130 outputs state comparisons using the descriptive states and the aspirational states (535). By way of example, the user can input into a web page rendered on user I/O system 110 by server system 130 a request to view his or her past descriptive states at a time specified by the user juxtaposed with his or her present descriptive states and aspirational states, relative to the persona facet. Turning to FIG. 9, in response to the request, server system 130 retrieves the requested information from user database 380 and renders on user I/O device 110 a web page displaying the requested information. The web page displays, for subfacets 910 within the persona facet, past descriptive states 920 in alignment with present descriptive states 930 and aspirational states 940.

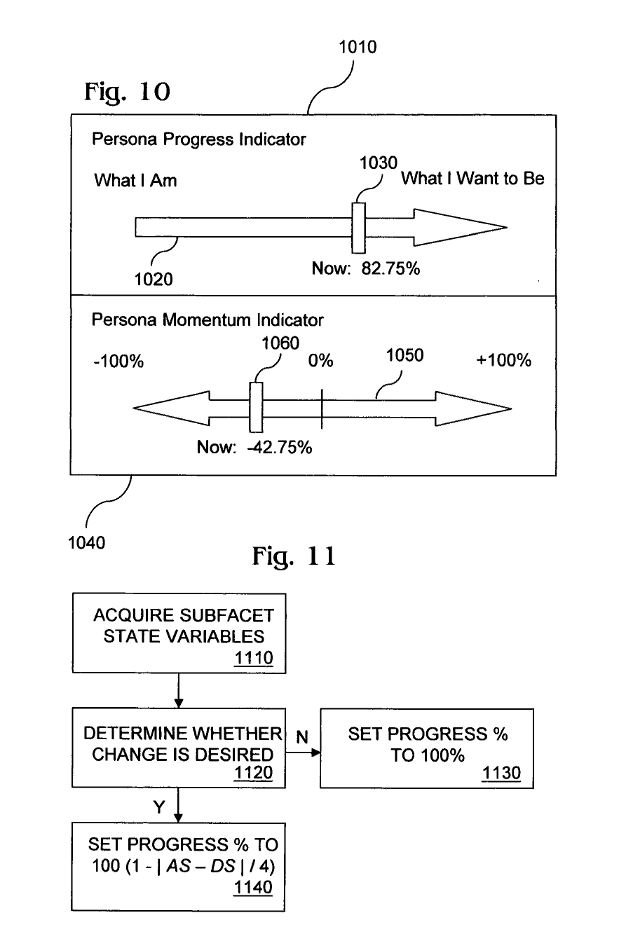

These perspectives also allow the user to assess his or her personal development relative to progress and momentum indicators. Progress indicators indicate the user's progress toward aspirational states relative to different facets and subfacets of his or her state of being, and is computed using aspirational states and descriptive states inputted by the user and stored in user database 380. Momentum indicators indicate the user's momentum relative to different facets and subfacets of his or her state of being, and is computed using perceptions inputted by the user and stored in user database 380. Accordingly, server system 130 calculates and outputs indicators using descriptive states, aspirational states and perceptions (540). By way of example, the user can input into a web page rendered on user I/O system 110 by server system 130 a request to view progress and momentum indicators relative to the persona facet. Turning to FIG. 10, in response, server system 130 retrieves from user database 380 information necessary to generate the requested indicators, generates the requested indicators and renders on user I/O device 110 a web page displaying the requested indicators. The web page includes a progress indicator 1010 for the persona facet presenting a progress arrow 1020 having a progress marker 1030 along its length indicating the user's progress toward the aspirational state. A progress percentage from 0% to 100% is provided on indicator 1010 adjacent to marker 1030. The web page also includes a momentum indicator 1040 for the persona facet presenting a bidirectional momentum arrow 1050 having a momentum marker 1060 along its length indicating the user's momentum. A momentum percentage from −100% to 100% is provided on indicator 1040 adjacent to marker 1060.

FIG. 11 shows a method for computing a progress percentage for a subfacet of a state of being in some embodiments of the invention. The method is performed by server system 130 under the control of processor 220. The subfacet may be a generic subfacet defined by a system administrator or a custom subfacet defined by a plan provider.

At the outset, state variables for the subfacet are acquired from user database 380 (1110). The state variables include a descriptive state (DS), an aspirational state (AS) and a change indicator. The descriptive state indicates what the user is relative to the subfacet. The aspirational state indicates what the user would like to be relative to the subfacet. The descriptive state and the aspirational state are integers between one and five, inclusive, with one being the least desirable state and five being the most desirable state. The change indicator indicates whether the user would like change relative to the subfacet. The change indicator is a binary value (e.g., 1=change is wanted, 0=change is not wanted).

Next, a determination is made whether the user wants change relative to the subfacet (1120). If it is determined that change is not desired, the progress percentage for the subfacet is set to 100% and the flow terminates (1130). The determination is made by reference to the change indicator.

If it is determined that change is desired, the progress percentage is computed according to the formula

100(1−|AS−DS|/4)

(1140). Thus, for example, if the aspirational state is five and the descriptive state is three, the progress percentage is 100 (1−0.5), or 50%.

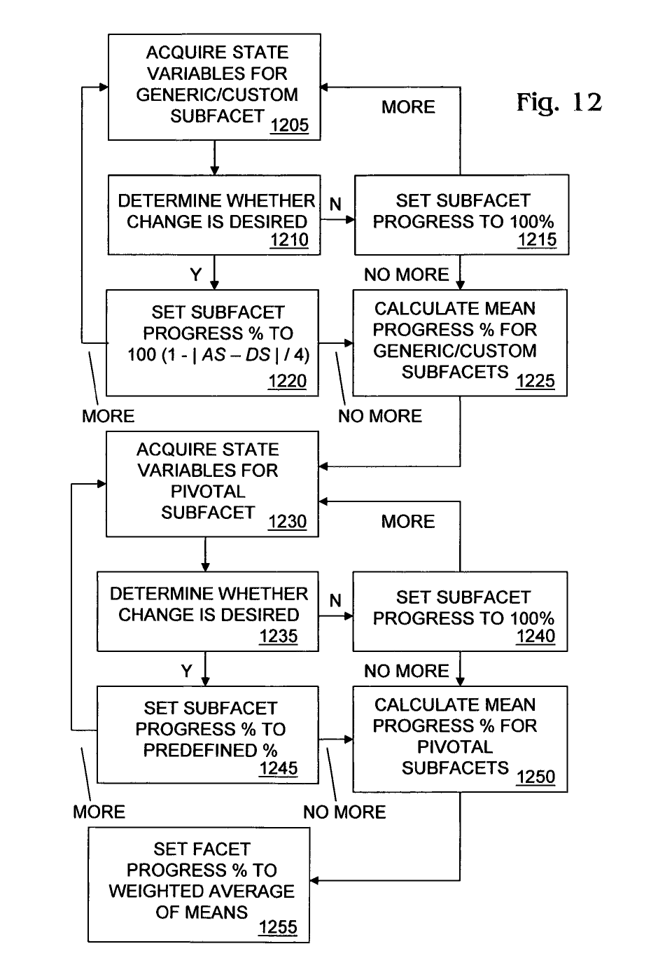

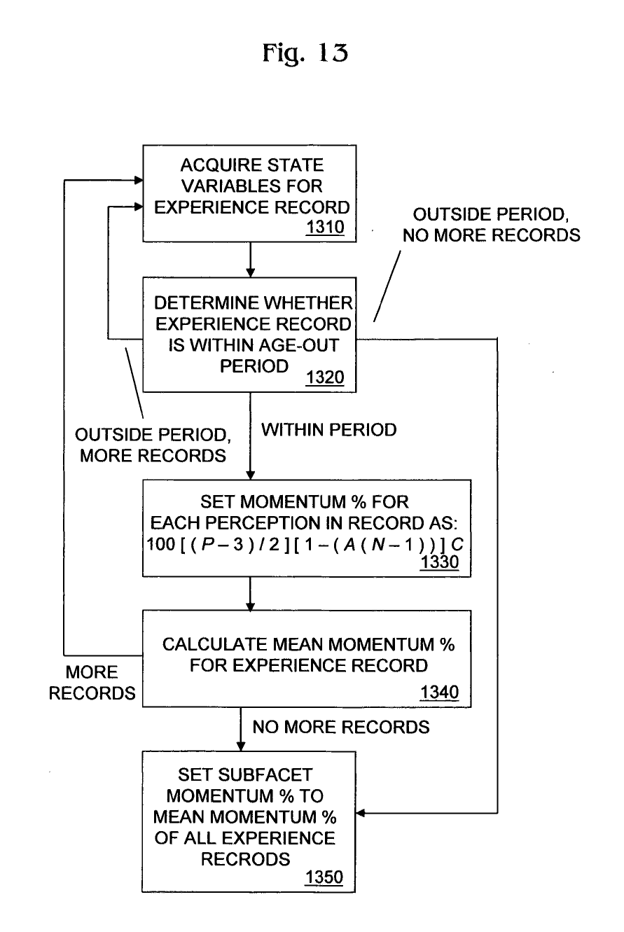

FIG. 12 shows a method for computing a progress percentage for a facet of a state of being in some embodiments of the invention. The method is performed by server system 130 under the control of processor 220. First, state variables for a first generic or custom subfacet within the facet are acquired from user database 380 (1205). The subfacet may be a generic subfacet defined by a system administrator or a custom subfacet defined by a plan provider. The state variables include a descriptive state, an aspirational state and a change indicator for the subfacet.

Next, a determination is made whether the user wants change relative to the subfacet (1210). The determination is made by reference to the change indicator. If it is determined that change is not desired, the progress percentage for the subfacet is set to 100% (1215) and the flow returns to Step 1205 for processing the next generic or custom subfacet within the facet. If there are no more generic or custom subfacets to be processed, the flow proceeds to Step 1225.

If it is determined that change is desired, the progress percentage for the subfacet is computed according to the formula

100(1−|AS−DS|/4)

(1220). The flow then returns to Step 1205 for processing of the next generic or custom subfacet within the facet. If there are no more generic or custom subfacets to be processed, the flow proceeds to Step 1225.

Next, a mean progress percentage for the generic and plan subfacets is computed (1225).

Next, state variables for a first pivotal subfacet defined by the user are acquired from user database 380 (1230). The state variables include a change indicator for the pivotal subfacet.

Next, a determination is made whether the user wants change relative to the pivotal subfacet (1235). The determination is made by reference to the change indicator. If it is determined that change is not desired, the progress percentage for the subfacet is set to 100% (1240) and the flow returns to Step 1230 for processing the next pivotal subfacet. If there are no more pivotal subfacets to be processed, the flow proceeds to Step 1250.

If it is determined that change is desired, the progress percentage for the pivotal subfacet is set to a predefined percentage between 0% and 100%. The flow then returns to Step 1230 for processing of the next pivotal subfacet. If there are no more pivotal subfacets to be processed, the flow proceeds to Step 1250.

Next, a mean progress percentage for the pivotal subfacets is computed (1250).

Finally, the progress percentage for the facet is computed as the weighted average of the means computed for the generic/custom subfacets (at Step 1225) and the pivotal subfacets (at Step 1250) (1255). The generic/plan subfacet mean is multiplied by a first weight that is between zero and one and the pivotal subfacet mean is multiplied by a second weight that is between zero and one, where the sum of the weights is one. The resulting products are then summed to compute the progress percentage for the facet. The weights may be defined by the system administrator, the user or a plan provider.

FIG. 13 shows a method for computing a momentum percentage for a subfacet of a state of being in some embodiments of the invention. First, state variables for a first experience record are acquired from user database 380 (1310). The state variables include multiple perceptions and a timestamp shared by the perceptions. The perceptions were inputted by the user in an input session relative to experiences, time-stamped and recorded in user database 380. The perceptions are integers between one and five, inclusive, with one being the least favorable and five being the most favorable. The timestamp documents the time at which the perceptions were recorded.

Next, a determination is made whether the experience record is within an age-out period defined on server system 130 by a system administrator or plan provider (1320). The determination is made by computing, using the timestamp, the number of experience update periods that have elapsed since the perceptions were recorded and comparing the number of experience update periods with the age-out period. If it is determined that the experience record is outside the age-out period and there are more experience records to be processed, the flow returns to Step 1310 for processing of the next experience record. If it is determined that the experience record is outside the age-out period there are no more experience records to be processed, the flow advances to Step 1350.

If it is determined that the experience record is within the age-out period, the momentum percentage for each perception in the experience record is computed according to the formula

100[(P−3)/2][1−(A(N−1)))]C

(1330). In the formula, P is the perception from the experience record reported by the user. P is an integer between one and five, inclusive, with one being the least favorable perception and five being the most favorable perception. A is an aging function for the experience defined by the system administrator or plan provider. A has a value between zero and one, with higher values being assigned to experiences for which the value of perceptions decays more rapidly. N is the number of experience update periods that have elapsed since the perception was recorded, wherein the time of an experience update period is defined by the system administrator. Finally, C is an experience/facet or experience/subfacet correlation index that measures the impact of the experience on the subfacet or the facet to which the subfacet belongs. C is assigned by the system administrator or a plan provider and has a value between zero and one, with higher values reflecting higher correlations. Consider, for example, an experience defined as “eat and drink healthy” for which four experience update periods ago the user reported a perception of two, a plan provider assigned an aging function value of 0.2 and the plan provider assigned an experience/subfacet correlation index of 1.0 relative to a subfacet described as “my health conditions.” In that event, the momentum percentage for this perception in this experience record would be computed as 100 [−0.5] [0.4] 1.0, or −20%.

Next, a mean momentum percentage for the experience record as a whole is computed from the momentum percentages computed for the individual perceptions (1340). If there are more experience records, the flow then returns to Step 1310 and the next experience record is processed.

If there are no more experience records, a mean momentum percentage for the subfacet is computed from the mean momentum percentages computed for the subfacet across all experience records (1350).

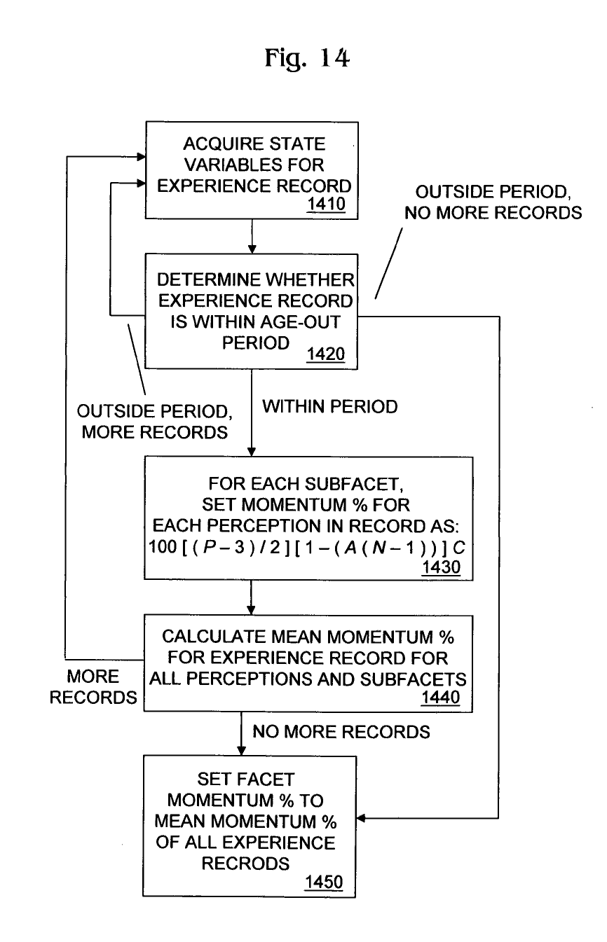

FIG. 14 shows a method for computing a momentum percentage for a facet of a state of being in some embodiments of the invention. Steps 1410-1430 are identical to their counterpart Steps 1310-1330, except that at Step 1430 the momentum percentage for each perception in the experience record is individually computed for each subfacet within the facet. Then, at Step 1440, a mean momentum percentage for the experience record as a whole is computed from the momentum percentages computed for the individual perceptions from each subfacet within the facet. Finally, at Step 1450, a mean momentum percentage for the facet is computed from the mean momentum percentages computed for the facet across all experience records.

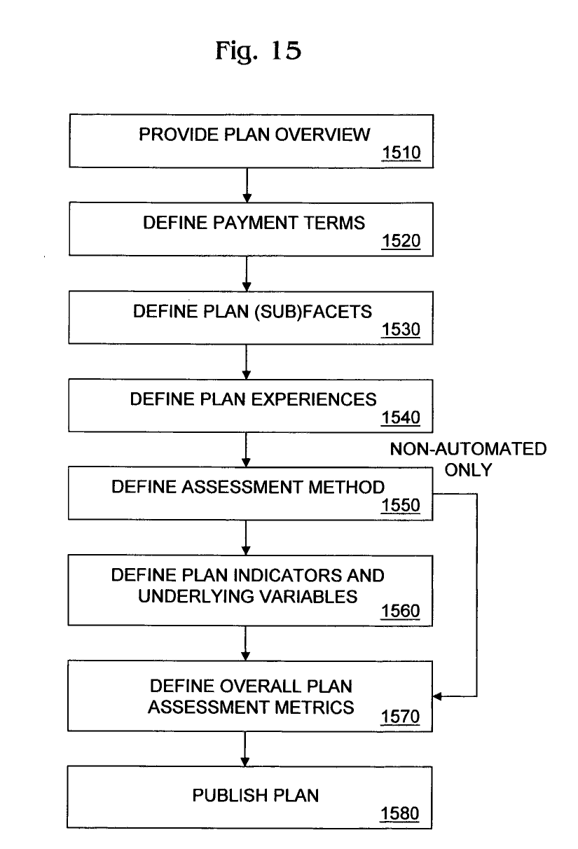

FIG. 15 is a flow diagram of a method for creating a personal development plan in some embodiments of the invention. Plan creation module 360 renders web pages on provider I/O system 120 that solicit information required for plan creation when invoked by a plan provider.

At the outset, the plan provider provides a plan overview (1510). The plan overview includes a plan name, a provider name, a provider background, provider contact information, plan testimonials, a plan summary and an indication of how often a user is expected to input perceptions relative to plan experiences.

The plan provider also defines payment terms for the plan (1520). The payment terms include an indication of whether participation in the plan is free or payment is required and, if payment is required, a list price.

The plan provider also defines plan facets and/or subfacets (1530). These are facets and/or subfacets of the user's life targeted for improvement by the plan. In some embodiments, plan facets and subfacets are selected from among the generic facets and subfacets predefined by the system administrator. With regard to generic subfacets, the plan provider may recommend aspirational states. In other embodiments, plan facets and subfacets include custom facets and/or subfacets defined by the plan provider. With regard to custom subfacets, the plan provider defines aspirational states. Plan subfacets may also include pivotal subfacets defined by the user.

The plan provider also defines plan experiences (1540). Plan experiences may include experiences selected from among the generic experiences predefined by the system administrator as well as custom experiences defined by the plan provider. The plan provider specifies a valid range of perceptions (e.g., a score from one to five, with five being the most favorable) for plan experiences.

The plan provider also defines a participant assessment method (1550). Assessments deliver feedback to users, such as encouragement and evaluation. The plan provider selects from among three assessment methods which are not mutually exclusive. One assessment method is real-time assessment. In real-time assessment, the plan provider commits to participating in a number of live chat sessions with the user of a given minimum duration and at a given frequency to provide assessments relative to the plan. If the plan provider selects real-time assessment, the plan provider defines the number of live chat sessions, a minimum duration, and a session frequency.

Another assessment method is non-real-time assessment. In non-real-time assessment, the plan provider commits to sending a number of written messages to the user at a given frequency to provide assessments relative to the plan. If the plan provider selects non-real-time assessment, the plan provider defines the number of messages and a message frequency.

Another assessment method is automated assessment. In automated assessment, server system 130 is invoked to provide feedback to the user in the form of progress, momentum and/or state indicators defined by the plan provider relative to the plan. When prompted by the user, server system 130 calculates and outputs the plan indicators.

If the plan provider selects automated assessment as an assessment method, the plan provider provides additional information regarding plan indicators and underlying variables (1560). For example, if plan indicators include facet progress indicators, the plan provider defines a subfacet progress percentage for pivotal subfacets for which change is desired and relative weights assigned to generic/custom and pivotal subfacets for computing the facet progress percentage as the weighted average of means. If plan indicators include facet or subfacet momentum indicators, the plan provider defines the aging function for each experience that impacts on the momentum indicators (A), the time of an experience update period, and experience/facet or/subfacet correlation indices that measure the impact of each experience on the facet or subfacet (C).

The plan provider also defines overall plan assessment metrics which may be quantitative (e.g., a score from one to five, with five being the most favorable) or qualitative in nature (1570).

Finally, the plan provider publishes the plan (1580), at which point the plan is added to a list of plans, stored in plan database 390, that can be accessed by users of the system in accordance with the terms specified by the plan provider.

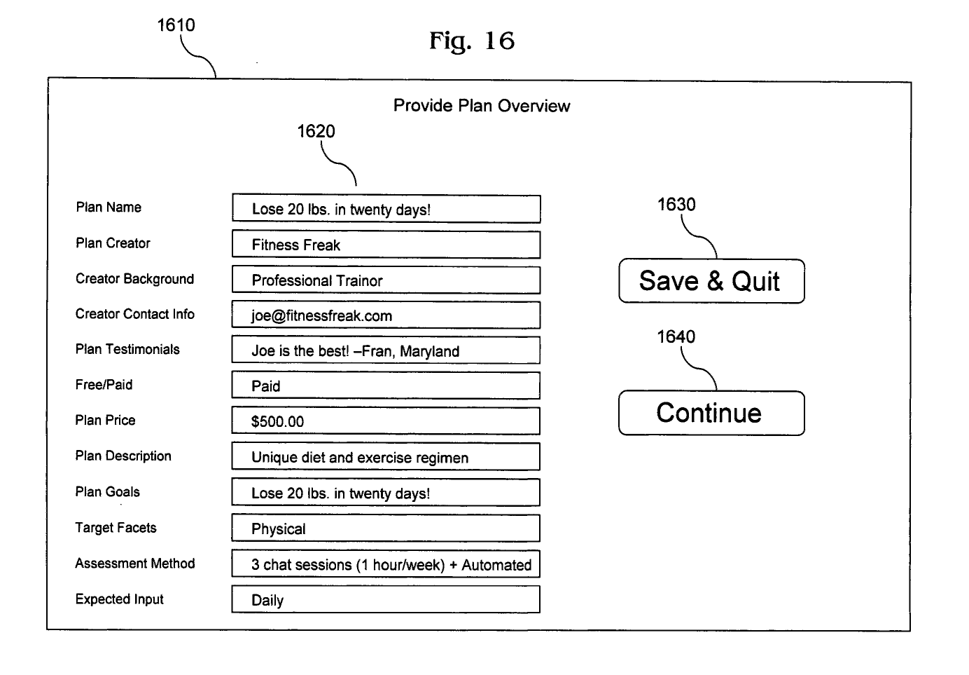

FIGS. 16-20 show exemplary user screens presented to a plan provider during plan creation and publication. Turning to FIG. 16, plan provider is first presented with a plan overview user screen 1610 whereon the plan provider provides a plan overview by inputting information in plan overview fields 1620. Once the plan provider is satisfied with the overview, the plan provider clicks a continue button 1640 to advance to the next plan creation screen. If the plan provider has to leave the session before he or she is satisfied with the overview, the plan provider can click the save and quit button 1630 and resume plan creation at a later time convenient for the plan provider.

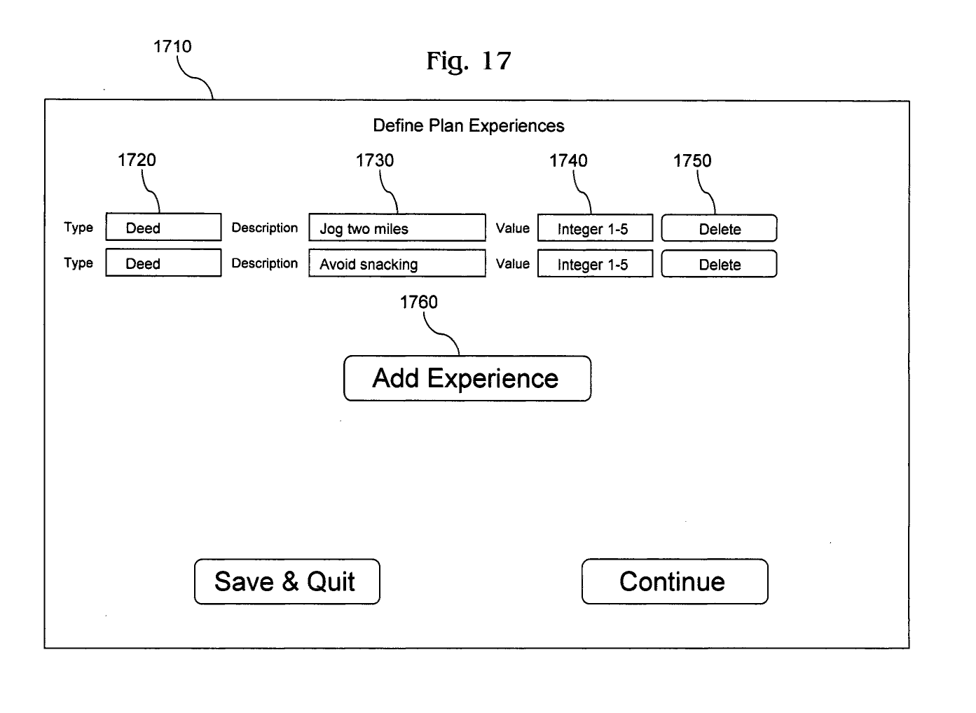

Turning to FIG. 17, the plan provider is next presented with a plan experiences screen 1710 whereon the plan provider defines experiences for the plan. For each experience, the plan provider inputs an experience category in experience category field 1720, an experience description in experience field 1730 and a valid perception range in perception range field 1740. When the plan provider is satisfied with an experience definition, the plan provider can click add experience button 1760 and define another experience. Moreover, the plan provider can delete an experience by clicking a delete button 1750 adjacent to the experience. Once the plan provider is satisfied with all experience definitions, the plan provider clicks a continue button to advance to the next plan creation screen. If the plan provider has to leave the session before he or she is satisfied with all experience definitions, the plan provider can click the save and quit button and resume plan creation at a later time convenient for the plan provider.

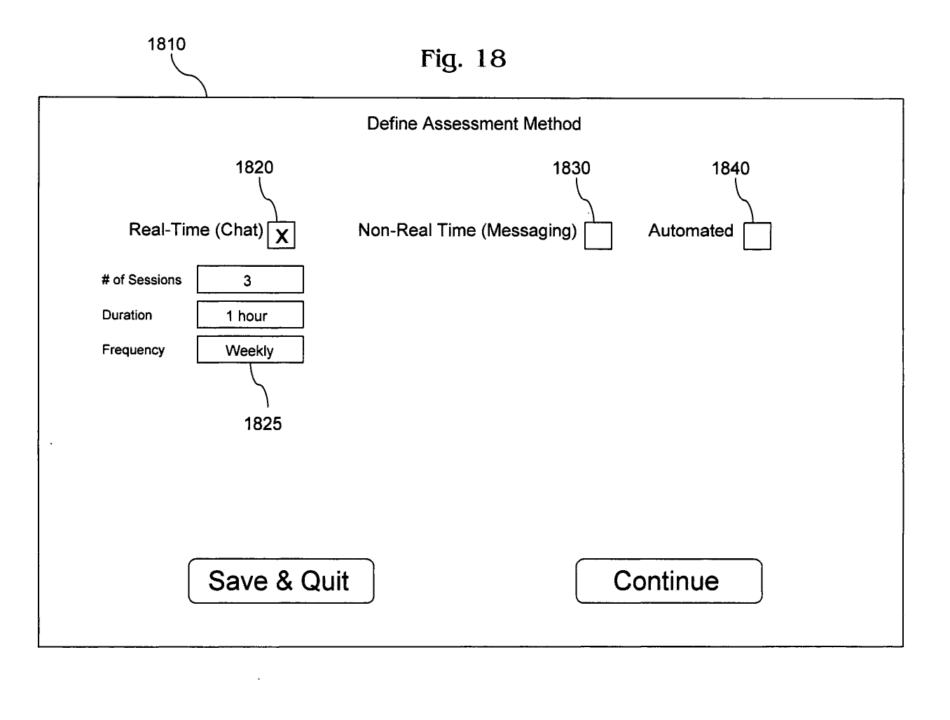

Turning to FIG. 18, the plan provider is next presented with an assessment method screen 1810 whereon the plan provider defines one or more assessment methods for the plan. The plan provider clicks one or more of checkboxes 1820, 1830, 1840 to select one or more of the real-time (chat), non-real-time (messaging) or automated assessment methods. For each selected assessment method, the plan provider is prompted to input additional definitional information for the assessment method For example, if the plan provider selects the chat assessment method, the plan provider is prompted to input further definitional information in chat assessment method fields 1825 such as the number, duration and frequency of the chat sessions. Once the plan provider is satisfied with the assessment method definitions, the plan provider clicks a continue button to advance to the next plan creation user screen. If the plan provider has to leave the session before he or she is satisfied with the assessment method definitions, the plan provider can click the save and quit button and resume plan creation at a later time convenient for the plan provider.

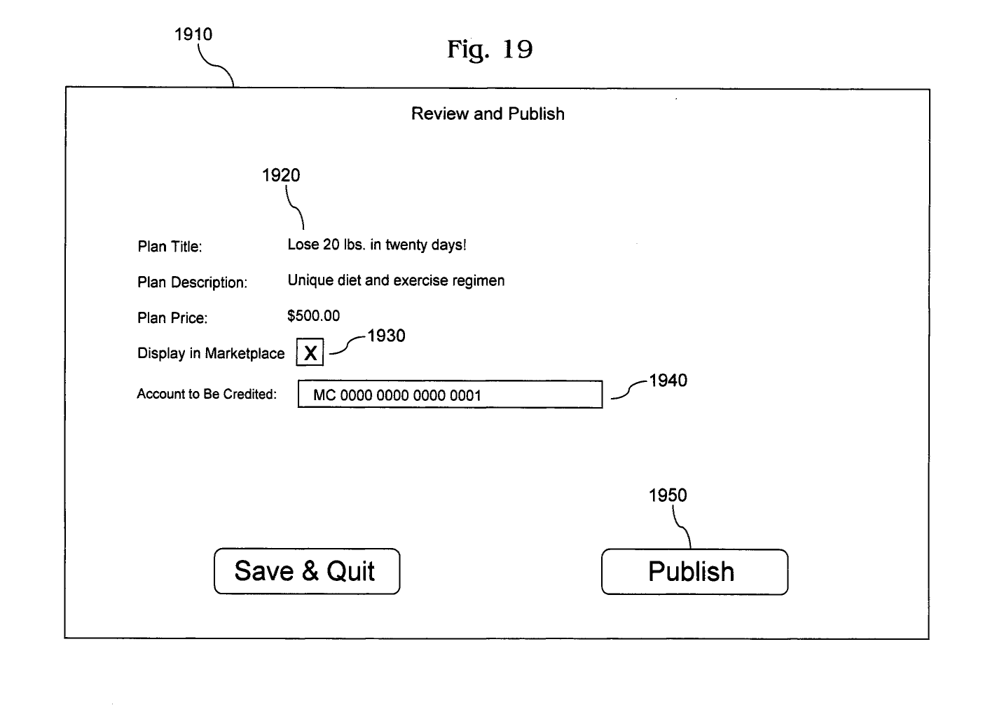

Turning to FIG. 19, the plan provider is next presented with a review/publication screen 1910 whereon the plan provider reviews plan details 1920, optionally clicks a checkbox 1930 indicating whether the plan provider wants the plan to be included in the personal development system's plan marketplace, inputs in an account field 1940 an account to be credited when the plan is purchased by a user of the system and clicks a publish button 1950 to publish the plan. If the plan provider has to leave the session before he or she is ready to publish, the plan provider can click a save and quit button and resume plan creation at a later time convenient for the plan provider.

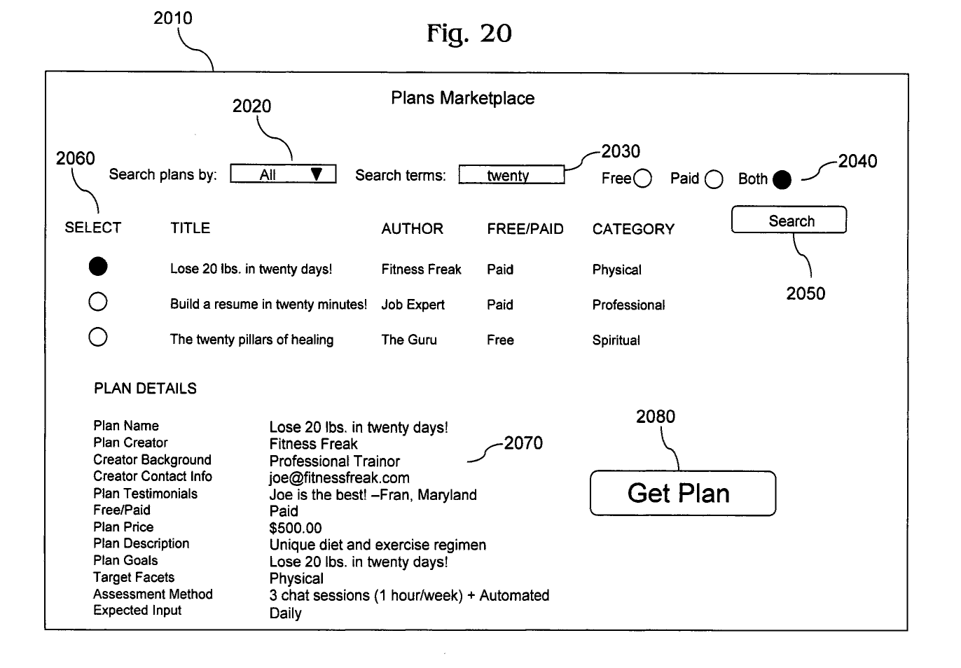

FIG. 20 shows a plan marketplace user screen 2010 in some embodiments of the invention. Plan marketplace user screen 2010 is presented to users of the system who wish to browse and possibly acquire or purchase plans. To search plans, the user selects a search category from a pull down menu 2020. For example, the user may search all plans or by author, category or title. The user also inputs a search term into a query box 2030 and checks one of radio buttons 2040 indicating whether unpaid, paid or both unpaid and paid plans should be included in the search results. The user then clicks a search button 2050 at which point search results matching the search query are returned. The user then selects a search result of interest by clicking a radio button 2060 and plan details 2070 for the selected search result appear. The user may at that point acquire or purchase the plan by clicking a get plan button 2080. If the user clicks get plan button 2080, the user is presented with further user screens which enable the user to pay for the plan and import the plan into the user's account.

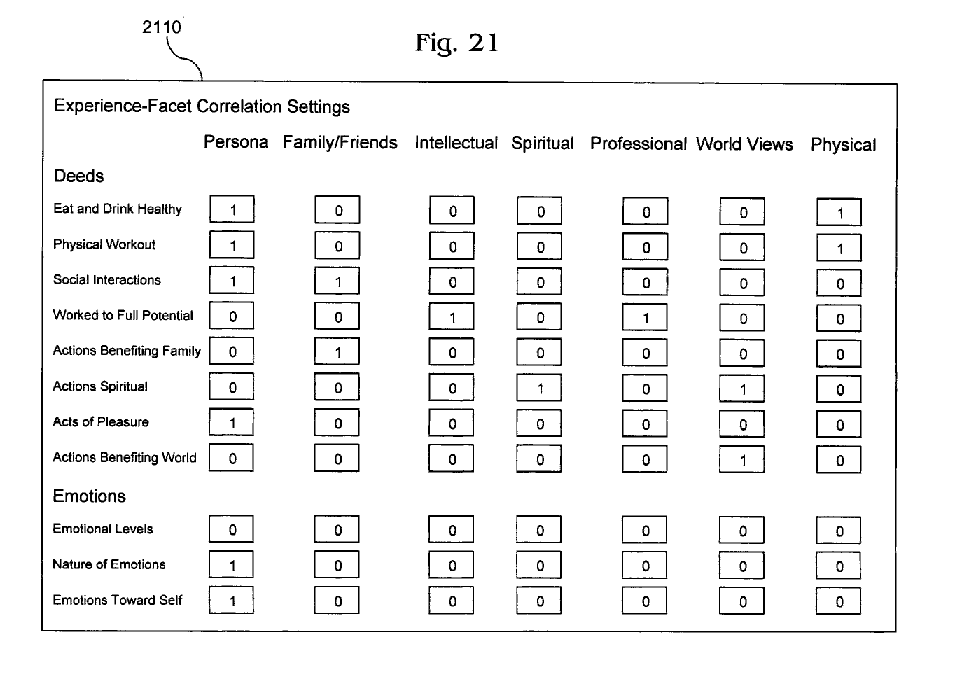

FIG. 21 is a user screen 2110 for viewing and modifying experience-facet correlations in some embodiments of the invention. User screen 2110 is used by a system administrator to define the impact of experiences on facets (and by extension to define the impact of experiences on subfacets within these facets) for purposes of computing momentum indicators. User screen 2110 presents a matrix of experiences and facets and the system administrator assigns values between zero and one, inclusive, to each experience/facet combination in the matrix. These assigned values are the experience/facet correlation indices (C) that are applied by indicator computation engine 375 to compute momentum indicators.

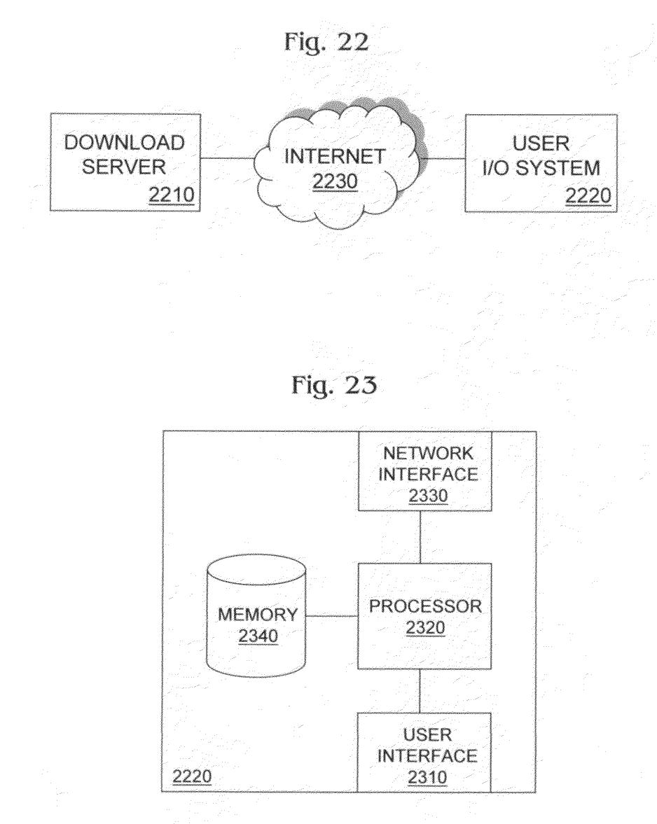

FIG. 22 shows a communication system in which the invention is operative in client-centric embodiments. FIG. 18 shows a user I/O system 2220 in these embodiments. User I/O system 2220 may be, for example, a desktop computer, notebook computer, tablet computer (e.g., iPad), netbook computer, smart phone (e.g., iPhone) or Internet appliance (e.g., iPod Touch). In client-centric embodiments, a version of the experience, facet, indicator and plan creation modules, indicator computation engine and non-secure elements of the user and plan databases are bundled as a client application and downloaded by a download server 2210 to user I/O system 2220 via the Internet 2230 (e.g., from Apple Inc.'s AppStore). User I/O system 2220 receives the client application via network interface 2330, and installs the client application in memory 2340 under the control of a processor 2320. A user boots the client application through inputs on a user interface 2310 and can locally access through user interface 2310, under the control of processor 2320 executing client application instructions, features of the personal development assessment method and system that have been previously described in connection with server-side embodiments.

Client application supported features include, for example, inputting pivotal subfacets, inputting descriptive and aspirational states relative to subfacets, inputting perceptions for experiences, viewing state comparisons involving past and present descriptive states and aspirational states, viewing indicators computed using descriptive states, aspirational states and perceptions, plan creation and plan search and retrieval. Thus, by way of example, user I/O system 2320 receives via user interface 2310 descriptive states inputted by a human user over time relative to a plurality of defined subfacets of a state of being within each of a plurality of defined facets of a state of being, under control of processor 2320 records in memory 2340 the descriptive states, receives via user interface 2310 a request from the user to output information relative to one or more of the subfacets within one of the facets based at least in part on descriptive states relative to the one or more subfacets, under control of processor 2320 retrieves from memory 2340 in response to the request descriptive states relative to the one or more subfacets and outputs via user interface 2310 the requested information. By way of further example, user I/O system 2320 receives via user interface 2310 perceptions inputted by a human user over time relative to a plurality of defined experiences within each of a plurality of defined experience categories, under control of processor 2320 records in memory 2340 the perceptions, receives via user interface 2310 a request from the user to output information relative to one or more of the experiences, under control of processor 2320 retrieves from memory 2340 in response to the request perceptions relative to the one or more experiences, generates the requested information based at least in part on the retrieved perceptions and outputs via user interface 2310 the requested information.

The client application also enables the user to establish an Internet connection with a system server for purposes of acquiring or purchasing plans and to establish peer-to-peer Internet connections with user I/O devices of other users of the system for purposes of conducting chat sessions and message exchanges. It bears noting that client-centric embodiments have an advantage in allowing users to engage in personal development assessment during times when they have no Internet access.

It will be appreciated by those of ordinary skill in the art that the invention can be embodied in other specific forms without departing from the spirit or essential character hereof. The present description is thus considered in all respects to be illustrative and not restrictive. The scope of the invention is indicated by the appended claims, and all changes that come with in the meaning and range of equivalents thereof are intended to be embraced therein.

What is claimed is:

1. A method for providing a personal development plan marketplace in a multidimensional personal development system, comprising the steps of:
receiving, by a server system, from a plan provider, a personal development plan created by the plan provider, wherein the plan defines one or more experiences to be monitored under the plan and one or more facets of a state of being targeted by the plan;
adding the plan, by the server system, to a plan marketplace maintained by the server system;
receiving, by the server system, from a user, a request for information about plans in the plan marketplace;
transmitting, by the server system, to the user, information about the plan in response to the request;
receiving, by the server system, from the user, a request to acquire the plan;
importing the plan, by the server system, into an account of the user in response to the request;
receiving, by the server system, from the user, perceptions inputted by the user over time relative to the experiences; and
transmitting, by the server system, to the user, assessments of the plan provider over time relative to the user and the plan.

2. The method of claim 1, wherein the assessments are human assessments made in a live chat session.

3. The method of claim 1, wherein the assessments are human assessments made in messages outside of a live chat session.

4. The method of claim 1, wherein the assessments are automated assessments.

5. The method of claim 4, wherein the automated assessments comprise momentum indicators generated by the server system relative to the one or more facets.

6. The method of claim 4, wherein the automated assessments comprise progress indicators generated by the server system relative to the one or more facets.

7. The method of claim 1, wherein the assessments are based at least in part on the perceptions.

8. The method of claim 1, further comprising the step of receiving, by the server system, from the user, descriptive states inputted by the user over time relative to one more more subfacets within the one or more facets.

9. The method of claim 8, wherein the plan recommends aspirational states relative to the one or more subfacets.

10. The method of claim 8, wherein the plan defines asipirational states relative to the one or more subfacets.

11. The method of claim 8, wherein the assessments are based at least in part on the descriptive states.

12. The method of claim 1, further comprising the step of receiving, by the server system, from the user, payment information for the plan.

13. The method of claim 1, wherein the one or more facets include a persona facet.

14. The method of claim 1, wherein the one or more facets include a professional facet.

15. The method of claim 1, wherein the one or more facets include a spiritual facet.

16. The method of claim 1, wherein the one or more facets include an intellectual facet.

17. The method of claim 1, wherein the one or more facets include a family and friends facet.

18. The method of claim 1, wherein the one or more facets include a world views facet.

19. The method of claim 1, wherein the one or more facets include a physical facet.

20. The method of claim 1, wherein the experiences include deeds.

21. The method of claim 1, wherein the experiences include thoughts.

22. The method of claim 1, wherein the experiences include emotions.

23. The method of claim 1, wherein the experiences include random experiences.

24. A server system, comprising:
at least one network interface; and
a processor communicatively coupled with the network interface, wherein the server system receives from a plan provider via the network interface a personal development plan created by the plan provider, wherein the plan defines one or more experiences to be monitored under the plan and one or more facets of a state of being targeted by the plan, wherein the server system under control of the processor adds the plan to a plan marketplace maintained by the server system, wherein the server system receives from a user via the network interface a request for information about plans in the plan marketplace and transmits to the user via the network interface information about the plan in response to the request, wherein the server system receives from the user via the network interface a request to acquire the plan and under control of the processor imports the plan into an account of the user in response to the request, and wherein the server system receives from the user via the network interface perceptions inputted by the user over time relative to the experiences and transmits to the user via the network interface assessments of the plan provider over time relative to the user and the plan.

25. The server system of claim 24, wherein the assessments are human assessments made in a live chat session.

26. The server system of claim 24, wherein the assessments are human assessments made in messages outside of a live chat session.

27. The server system of claim 24, wherein the assessments are automated assessments.

28. The server system of claim 24, wherein the automated assessments comprise momentum indicators relative to the one or more facets generated by the server system under control of the processor.

29. The server system of claim 24, wherein the automated assessments comprise progress indicators relative to the one or more facets generated by the server system under control of the processor.

30. The server system of claim 24, wherein the assessments are based at least in part on the perceptions.

31. The server system of claim 24, wherein the server system further receives from the user via the network interface descriptive states inputted by the user over time relative to one more more subfacets within the one or more facets.

32. The server system of claim 31, wherein the plan recommends aspirational states relative to the one or more subfacets.

33. The server system of claim 31, wherein the plan defines asipirational states relative to the one or more subfacets.

34. The server system of claim 31, wherein the assessments are based at least in part on the descriptive states.

35. The server system of claim 24, wherein the server system further receives from the user via the network interface payment information for the plan.

36. A user input/output (I/O) system, comprising:
at least one user interface;
at least one network interface; and
a processor communicatively coupled with the user interface and the network interface, wherein the user I/O system receives from a server system via the network interface a personal development plan created by a plan provider defining one or more experiences to be monitored under the plan and one or more facets of a state of being targeted by the plan, wherein the user I/O system under control of the processor imports the plan into an account of a user of the user I/O system, wherein the user I/O system receives from the user via the user interface perceptions inputted by the user over time relative to the experiences, and wherein the user I/O system transmits to the user via the user interface assessments of the plan provider over time relative to the user and the plan.

37. The user I/O system of claim 36, wherein the assessments are human assessments made in a live chat session.

38. The user I/O system of claim 36, wherein the assessments are human assessments made in messages outside of a live chat session.

39. The user I/O system of claim 36, wherein the assessments are automated assessments.

40. The user I/O system of claim 36, wherein the automated assessments comprise momentum indicators relative to the one or more facets generated by the user I/O system under control of the processor.

41. The user I/O system of claim 36, wherein the automated assessments comprise progress indicators relative to the one or more facets generated by the user I/O system under control of the processor.

42. The user I/O system of claim 36, wherein the assessments are based at least in part on the perceptions.

43. The user I/O system of claim 36, wherein the user I/O system further receives from the user via the user interface descriptive states inputted by the user over time relative to one more more subfacets within the one or more facets.

44. The user I/O system of claim 43, wherein the plan recommends aspirational states relative to the one or more subfacets.

45. The user I/O system of claim 43, wherein the plan defines asipirational states relative to the one or more subfacets.

46. The user I/O system of claim 43, wherein the assessments are based at least in part on the descriptive states.

47. The user I/O system of claim 36, wherein the server system further receives from the user via the network interface payment information for the plan.

48. A user I/O system, comprising:
at least one user interface; and
at least one network interface, wherein the user I/O system receives via the user interface from a plan provider a personal development plan defining one or more experiences to be monitored under the plan, one or more facets of a state of being targeted by the plan, one or more assessment methods for assessing users of the plan and payment information for the plan, and wherein the user I/O system transmits the plan to a server system via the network interface, whereupon the plan is added to a searchable plan marketplace.
